(19) United States
(12) Patent Application Publication
(10) Pub. No.: US 2026/0330743 A1
(43) Pub. Date: Oct. 22, 2026

(54) ALIGNMENT OF STRUCTURED TEXTURES

(71) Applicant: Adobe Inc., San Jose, CA (US)

(72) Inventors: Arthur Jules Martin Roullier, Paris (FR); Jerome Eric Christophe Derel, Hauts-de-Seine (FR)

(73) Assignee: Adobe Inc., San Jose, CA (US)

(21) Appl. No.: 19/183,644

(22) Filed: Apr. 18, 2025

(51) Int. Cl. G06T 15/04; G06T 3/02

(52) U.S. Cl. CPC G06T 15/04; G06T 3/02

(57) ABSTRACT

Techniques related to alignment of structured textures are described. In an example, a processing device is operable to obtain an unaligned input image of a structured texture, generate a frequency domain representation of at least a portion of the unaligned input image, and perform integral calculations on the frequency domain representation for a plurality of angles. The processing device is further operable to determine at least one alignment parameter for aligning the structured texture based on the integral calculations and produce an aligned output image of the structured texture by modifying the unaligned input image based on the at least one alignment parameter.

### BACKGROUND

Textures are applied to digital surfaces for introducing realism in digital content. Structured textures have repeating patterns arranged in regular formations. Lattice textures, for instance, are structured to follow a lattice. When a structured texture is applied to complex digital surfaces, multiple distortions, e.g., in texture rotation and shear, appear simultaneously and cause noticeable visual inconsistencies. Inability to compensate for lattice and other structured texture distortions inhibits the realism and quality of digital content.

### SUMMARY

Techniques for alignment of structured textures are described. An example system is configured as a digital content processing system, including a texturing tool for texturing digital content. The texturing tool efficiently aligns pattern features to prevent distortions in structured textures, without manual intervention. An unaligned input image of a structured texture is obtained, which forms the basis for a surface appearance. The texturing tool produces an aligned output image that is usable for texturing digital content with the structured texture, such that the surface appearance is uniform and free of rotational and shear distortions inferred from the unaligned input image. Distortions are removed by first generating a frequency domain representation of at least a portion of the unaligned input image. A power spectrum, which is a frequency domain representation of a crop of the unaligned input image, is generated. The power spectrum reveals frequency domain information about the texture's repeating patterns, enabling precise identification of structural characteristics otherwise difficult to detect in the spatial domain. With the frequency domain representation, integral calculations are performed on the power spectrum for a plurality of angles. For example, the integral calculations include a subset of a full Radon transform, limited to central rays passing through a center point of the frequency domain representation, which reduces computational overhead compared to conventional approaches that employ complete Radon transforms. At least one alignment parameter for the structured texture is determined based on the integral calculations. The at least one alignment parameter may include a rotation angle parameter, a shear axis parameter, and a shear angle parameter, which collectively define geometric transformations for aligning the texture. The system simultaneously estimates the rotation and shear parameters, enabling comprehensive texture alignment for complex real-world textures where both distortion types occur together. The system efficiently produces an aligned output image of the structured texture by modifying the unaligned input image based on the at least one alignment parameter. The aligned output images enable seamless application to 3D objects and digital surfaces. The frequency domain approach provides robustness to variations in pattern scale and intensity, improving alignment accuracy for various texture types including lattice-structured textures.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description includes references to the accompanying figures. Entities represented in the figures are indicative of one or more entities and thus reference is made interchangeably to single or plural forms of the entities in the discussion.

FIG. 1 is an illustration of an example environment that is operable to implement techniques described herein related to alignment of structured textures.

FIG. 2 is a block diagram depicting an example system that is operable to implement alignment of structured textures.

FIG. 3 is a conceptual diagram illustrating an example data flow through the example system depicted in FIG. 2 to implement alignment of structured textures.

FIG. 4 is a conceptual diagram illustrating example alignment transformations applied by the example system depicted in FIG. 2 to implement alignment of structured textures.

FIG. 5 is an illustration of example unaligned input images and aligned output images generated using techniques described herein related to alignment of structured textures.

FIG. 6 is a flow diagram depicting an algorithm as a step-by-step process, which is performable by a processing device to implement techniques described herein for aligning structured textures.

FIG. 7 illustrates an example system including various components of an example device usable as any type of computing device as described and/or utilized with reference to FIGS. 1-6 to implement examples of the techniques described herein.

### DETAILED DESCRIPTION

### Overview

Textures are applied to digital surfaces for introducing realism in digital content. Structured textures have repeating patterns arranged in regular formations. Lattice textures, for instance, are structured to follow a lattice. When a structured texture is applied to complex digital surfaces, multiple distortions in texture rotation and shear can appear simultaneously, causing noticeable visual inconsistencies. Inability to compensate for lattice and other structured texture distortions inhibits the realism and quality of digital content.

Conventional approaches to texture alignment support manual adjustments and various automatic feature extraction techniques. However, identifying, and correcting distortions that occur simultaneously in rotation and shear is difficult, even for experts or sophisticated systems. As complexity of texture patterns increases, manual alignment is time-consuming, and convention automations are error prone. For example, some automated solutions employ full Radon transforms or Hough line detection to identify texture orientations, but these approaches are computationally intensive and impractical for high-resolution images. Full Radon transform approaches calculate integrals along each possible parallel line at various angles, potentially consuming substantial processing resources. Hough line-based techniques operate at slower speeds and primarily address rotation estimation without handling shear distortions. In addition to inefficiencies, conventional approaches address part of the realism problem by focusing on rotational alignment corrections, while shear deformations remain. Achieving precise alignment in both rotation and shear enables realistic application of structured textures to digital surfaces and 3D objects.

An example system implements techniques for alignment of structured textures. The system is configured as a digital content processing system, including a texturing tool for texturing the digital content. The texturing tool of the system implements an automated texture alignment solution addressing misalignments in textures without manual intervention or extensive computational resources. The texturing tool obtains an unaligned input image of a structured texture that forms the basis for a surface appearance and produces an aligned output image that is usable for texturing digital content with the structured texture. The texturing tool generates a power spectrum, which is a frequency domain representation, from a crop of the unaligned input image and performs integral calculations on the power spectrum across multiple angles. The power spectrum reveals frequency domain information about the texture's repeating patterns, enabling precise identification of structural characteristics otherwise difficult to detect in the spatial domain.

By determining at least one alignment parameter based on integral calculations in the frequency domain, the system efficiently transforms the unaligned input image to an aligned output image. The alignment parameters, in variations, include a rotation angle parameter, a shear axis parameter, and a shear angle parameter, which collectively define geometric transformations for aligning the texture. The integral calculations, in examples, include a subset of a full Radon transform limited to central rays passing through a center point of the frequency domain representation, reducing computational overhead compared to conventional approaches that employ complete Radon transforms, which possibly improves processing speed while maintaining alignment accuracy, e.g., in support of real-time applications and high-resolution texture processing. The system is capable of simultaneously estimating the rotation and shear parameters, enabling comprehensive texture alignment for complex real-world textures where both distortion types occur together, providing a more complete solution than single-parameter approaches.

The combined correction capability improves rectification of textures with multiple types of misalignments in a single processing pass, eliminating repetitive correction attempts. The frequency domain approach provides robustness to variations in pattern scale and intensity, improving alignment accuracy for various texture types including lattice-structured textures such as quadrilateral, hexagonal, herringbone, checkered, polka dot, plaid, interleaved, and woven lattice patterns. The scale and intensity invariance enables processing of textures captured under different conditions (e.g., distances, orientations, resolutions, illuminances, etc.). The aligned output images enable seamless application to 3D objects and digital surfaces. The properly aligned textures eliminate visual artifacts and inconsistencies that otherwise appear when applying misaligned textures to complex 3D geometries or when tiling textures across large surfaces. The techniques operate using standard image processing libraries without specialized hardware or machine learning models, allowing broad deployment across various computing platforms and integration into existing digital content creation workflows.

Further discussion of these and other examples and advantages are included in the following sections and shown using corresponding figures. In the following discussion, an example environment is described that employs the techniques described herein. Example procedures are also described that are performable in the example environment as well as other environments. Consequently, performance of the example procedures is not limited to the example environment and the example environment is not limited to performance of the example procedures.

### Example Digital Content Production Environment

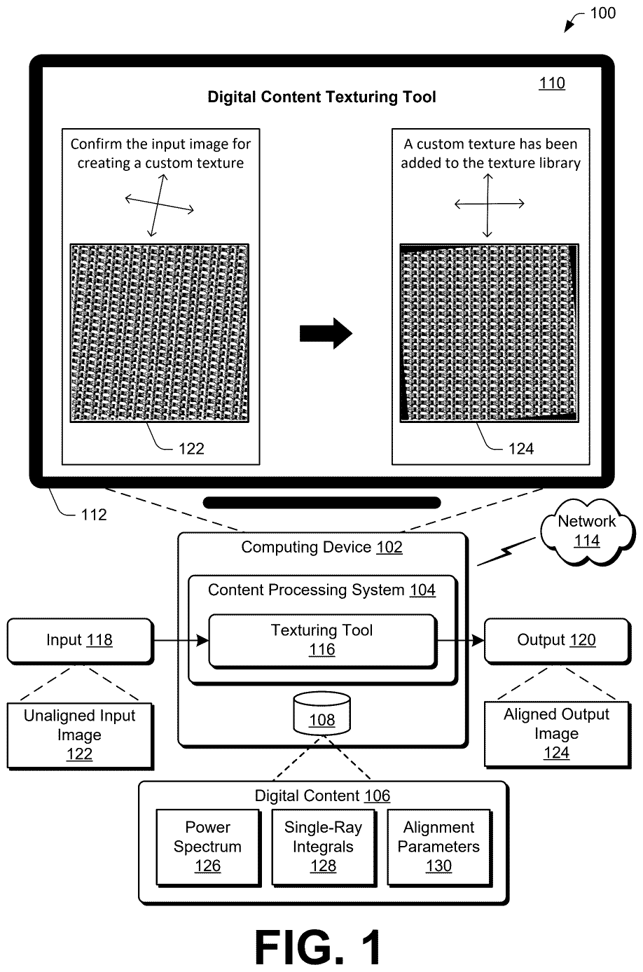

FIG. 1 is an illustration of an example environment 100 that is operable to implement techniques described herein related to alignment of structured textures. The environment 100 includes a computing device 102, which is configurable in a variety of ways.

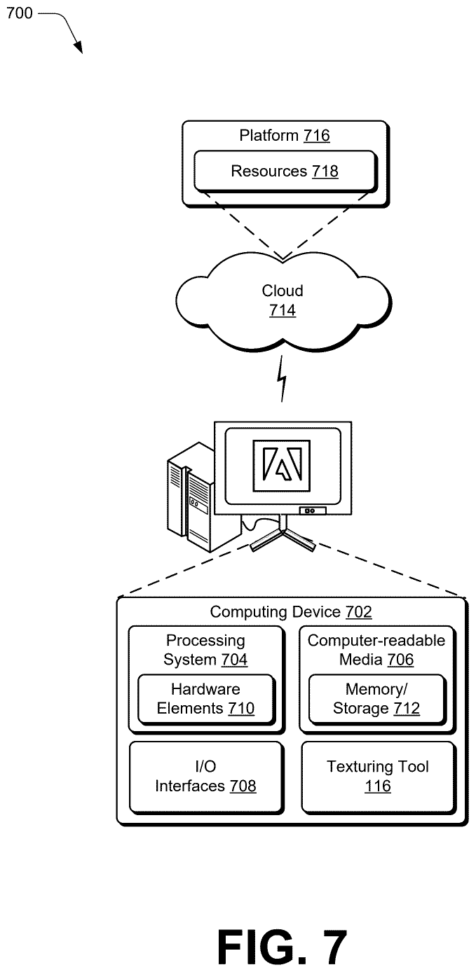

The computing device 102, for instance, is configurable as a processing device such as a desktop computer, a laptop computer, a mobile device (e.g., assuming a handheld configuration such as a tablet or mobile phone), and so forth. Thus, the computing device 102 ranges from full resource devices with substantial memory components and processor resources (e.g., personal computers, game consoles) to a low-resource device with limited memory and/or processing resources, e.g., mobile devices. Additionally, although a single computing device 102 is shown, the computing device 102 is also representative of a plurality of different devices (e.g., a computing system), such as multiple servers utilized by a business to perform operations “over the cloud” as described in FIG. 7.

The computing device 102 is illustrated as including a content processing system 104. The content processing system 104 is implemented at least partially in hardware of the computing device 102 to process and transform digital content 106, which is illustrated as being maintained in storage 108 of the computing device 102. Such processing includes creation of the digital content 106, modification of the digital content 106, and rendering or re-rendering of the digital content 106 for presentation in a user interface 110, e.g., for output by a display device 112. Although illustrated as implemented locally at the computing device 102, functionality of the content processing system 104 is also configurable in whole or in part through functionality available via the network 114, such as part of a web service or “in the cloud”.

The content processing system 104 implements a texturing tool 116 for processing the digital content 106. In variations, the texturing tool 116 is a software component, and in some cases, the texturing tool 116 includes a combination of hardware and software. Digital content authoring suites and graphic plugins are example implementations of the texturing tool 116, which provides texture processing capabilities for digital content creation workflows. The texturing tool 116 is configured to analyze and transform images of textures, to correct alignment issues in structured patterns, which enables the images to be used for texturing digital content. Without aligning the images of the textures, the images are not usable for texturing digital content (at least not without introducing noticeable distortions and visual artifacts). The texturing tool 116 receives an input 118 and generates an output 120. The texturing tool 116 implements frequency domain analysis on the input 118 to understand texture patterns and extract alignment parameters for generating the output 120. Operating on the input 118 in the frequency domain enables the system 104 to handle diverse input types, including unaligned structured texture images with various lattice patterns such as quadrilateral, hexagonal, herringbone, checkered, polka dot, plaid, interleaved, and woven textures.

The input 118 and output 120 are displayed in the user interface 110 on the display device 112, enabling efficient alignment of structured textures without specialized knowledge or manual adjustment of complex patterns. The input 118 to the texturing tool 116 includes an unaligned input image 122 of a structured texture. The unaligned input image 122 is a digital representation of a texture with a repeating pattern that where alignment correction to be properly applied for texturing digital surfaces. The texturing tool 116 processes various types of unaligned input images 122, such as fabric textures for virtual clothing, architectural patterns for building models, and material surfaces for product visualization. The input 118 may express texture patterns in various formats, including as portions of digital images, 3D model textures, or video frames including structured patterns. As illustrated in FIG. 1, the unaligned input image 122 has a lattice-structured texture with a repeating pattern that is at least slightly misaligned or distorted relative to canonical axes.

The texturing tool 116 processes the input 118 to generate the output 120, including an aligned output image 124. The aligned output image 124 is a digital representation of the structured texture with rotation and shear distortions corrected, enabling proper application for texturing digital surfaces. The output 120 shows the aligned output image 124 with the lattice pattern properly oriented and aligned with canonical axes, making it suitable for seamless tiling and consistent application across 3D models. For example, the aligned output image 124 can be applied to architectural surfaces, clothing models, product visualizations, or game environments where consistent texture alignment is achieved for visual realism. The aligned output image 124 maintains the original texture's visual characteristics while eliminating the misalignments that otherwise create visual inconsistencies when applied to complex digital surfaces.

To initiate the alignment process, a user may provide the input 118 with the unaligned input image 122 through the user interface 110 of the texturing tool 116. The texturing tool 116 generates a power spectrum 126 from a crop of the unaligned input image 122, which serves as a frequency domain representation revealing detailed information about the texture's repeating patterns. This power spectrum 126 exhibits peaks at frequencies corresponding to the repeating elements in the structured texture, enabling precise identification of structural characteristics that are difficult to detect in the spatial domain. The frequency domain approach provides robustness to variations in pattern scale and intensity, improving alignment accuracy for various texture types including lattice-structured textures such as quadrilateral, hexagonal, herringbone, checkered, polka dot, plaid, interleaved, and woven lattice patterns.

The texturing tool 116 then performs integral calculations on the power spectrum 126 for a plurality of angles. These integral calculations, referred to throughout as single-ray integrals 128, include a subset of a full Radon transform, limited to central rays passing through a center point of the power spectrum 126 (e.g., the frequency domain representation). For each angle of the plurality of angles, the texturing tool 116 computes each of the single-ray integrals 128 as an integral of intensity values along a central ray passing at that angle through the center point of the frequency domain representation. This targeted approach significantly reduces computational overhead compared to conventional methods that employ complete Radon transforms or Hough line detection, enabling efficient processing of high-resolution textures while maintaining alignment accuracy. The reduced computational resource capabilities for generating the single-ray integrals 128 make this approach compatible with real-time applications and processing of complex texture patterns without specialized hardware acceleration.

Based on the single-ray integrals 128, the texturing tool 116 determines at least one alignment parameter 130 for the structured texture. These alignment parameters 130 may include a rotation angle parameter, a shear axis parameter, and a shear angle parameter, which collectively define geometric transformations for aligning the texture. The texturing tool 116 identifies, based on the integral calculations (e.g., the single-ray integrals 128), a first angle from the plurality of angles corresponding to a first maximum integral value of the single-ray integrals 128. The rotation angle parameter is set based on this first angle. The tool 116 can perform additional integral calculations on the frequency domain representation for a second plurality of angles to identify a second angle corresponding to a second maximum integral value from the single-ray integrals 128. A shear axis parameter is determinable based on a comparison between the rotation angle parameter and the second angle. This simultaneous estimation of rotation and shear parameters enables comprehensive texture alignment for complex real-world textures where both distortion types occur together.

The texturing tool 116 then produces an aligned output image 124 of the structured texture by modifying the unaligned input image 122 based on the at least one alignment parameter 130. This modification includes applying rotation and shear transformations to the unaligned input image based on the determined rotation angle parameter, the shear axis parameter, and the shear angle parameter of the alignment parameters 130. The process efficiently corrects multiple types of misalignments in a single processing pass, eliminating repetitive correction attempts. The combined correction capability improves rectification of textures with multiple types of misalignments simultaneously, preserving the texture's visual characteristics while eliminating distortions that otherwise create visual inconsistencies when applied to complex digital surfaces.

The texturing tool 116 stores the aligned output image 124 in the digital content 106 maintained in storage 108, making it available for texturing digital content. The aligned output image 124 enables seamless application to 3D objects and digital surfaces, eliminating visual artifacts and inconsistencies that otherwise appear when applying misaligned textures to complex 3D geometries or when tiling textures across large surfaces. The texturing tool 116 also displays the aligned output image 124 in the user interface 110 as a selectable texture for texturing digital content, allowing users to easily apply the corrected texture to digital surfaces. The properly aligned textures maintain consistent orientation across curved or complex surfaces, enhancing the realism and quality of textured digital content.

As illustrated in FIG. 1, the texturing tool 116 enables efficient alignment of structured textures without requiring specialized hardware or machine learning models. The frequency domain approach provides robustness to variations in pattern scale and intensity, improving alignment accuracy for various texture types including lattice-structured textures such as quadrilateral, hexagonal, herringbone, checkered, polka dot, plaid, interleaved, and woven patterns. By addressing both rotation and shear distortions simultaneously, the texturing tool 116 provides a more complete solution than conventional approaches that focus solely on rotation correction, improving the overall quality and realism of textured digital content.

The texturing tool 116 is particularly useful for creating tileable textures that can be applied seamlessly to 3D objects and digital surfaces of various sizes. The aligned output images 124 eliminate visual artifacts and inconsistencies that otherwise appear when applying misaligned textures to complex 3D geometries or when tiling textures across large surfaces. The method is applicable to any structured texture image, regardless of size or source, providing a versatile solution for diverse digital content creation scenarios. The reduced computational requirements of the single-ray integrals 128 compared to conventional approaches that employ complete Radon transforms enables efficient processing of high-resolution textures while maintaining alignment accuracy, making it suitable for real-time applications without specialized hardware acceleration.

In general, functionality, features, and concepts described in relation to the examples above and below are employed in the context of the example procedures described in this section. Further, functionality, features, and concepts described in relation to different figures and examples in this document are interchangeable among one another and are not limited to implementation in the context of a particular figure or procedure. Moreover, blocks associated with different representative procedures and corresponding figures herein are applicable together and/or combinable in different ways. Thus, individual functionality, features, and concepts described in relation to different example environments, devices, components, figures, and procedures herein are usable in any suitable combinations and are not limited to the particular combinations represented by the enumerated examples in this description.

### Example Architecture of Alignment of Structured Textures

The following discussion describes alignment of structured texture techniques that are implementable utilizing the previously described systems and devices. Aspects of each of the procedures are implemented in hardware, firmware, software, or a combination thereof. The procedures are shown as a set of blocks that specify operations performed by one or more devices and are not limited to the orders shown for performing the operations by the respective blocks.

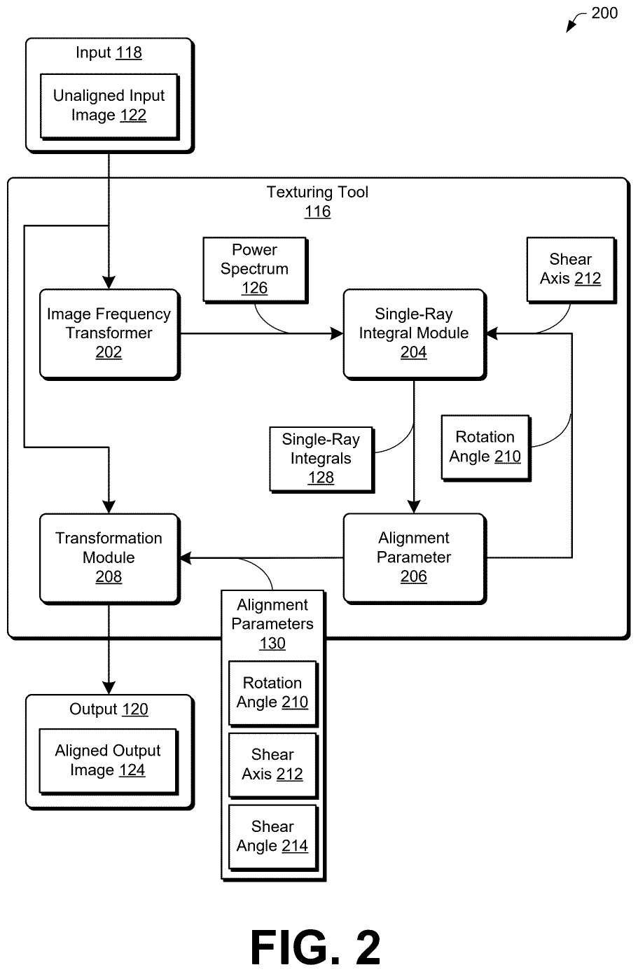

FIG. 2 depicts an example content processing system 200 that is operable to implement alignment of structured textures. The content processing system 200 illustrates an implementation of the texturing tool 116 of the content processing system 104, shown in greater detail than in FIG. 1. By integrating frequency domain analysis with efficient calculations of the single-ray integrals 128, the content processing system 200 is operable to perform accurate and efficient alignment of structured textures.

The content processing system 200 includes interconnected components that efficiently align structured textures. The texturing tool 116 combines frequency domain analysis with geometric transformation techniques to convert unaligned input images 122 into properly aligned output images 124. In the illustrated example, the content processing system 200 implements a texturing tool 116 that processes an input 118 including an unaligned input image 122 and produces an output 120 with an aligned output image 124 properly oriented with respect to canonical axes.

When a user provides the input 118 through the user interface 110, the texturing tool 116 applies frequency domain transformation to convert the spatial information of the unaligned input image 122 into a frequency representation. The texturing tool 116 includes a frequency transformer module 202 that processes the unaligned input image 122 to generate a power spectrum 126. The frequency transformer module 202 analyzes the unaligned input image 122 by sampling a crop of the unaligned input image 122 and computing a power spectrum 126 that exhibits peaks at frequencies corresponding to repeating patterns in the structured texture.

The frequency transformer module 202 converts spatial domain information into frequency domain representations by taking the central square crop from the unaligned input image 122 and computing a power spectrum 126. The power spectrum 126 reveals frequency information about texture's repeating patterns, enabling identification of structural characteristics difficult to detect in the spatial domain. The power spectrum 126 summarizes pattern repetition, making diverse patterns appear similar regardless of specific texture details, which simplifies the problem to realigning a pattern of dots in the frequency domain. The power spectrum 126 provides a robust representation of structural characteristics regardless of variations in pattern scale and intensity.

The frequency transformer module 202 is operable to process various input formats, including lattice-structured textures with quadrilateral, hexagonal, herringbone, and other patterns. The frequency transformer module 202 treats these as patterns with repeating elements arranged in regular formations. Using a square crop simplifies the relationship between image-space and frequency-space transformations. For square images, power spectrum 126 and raw unaligned input image 122 rotate identically, while for shear, the power spectrum 126 is sheared by the same angle but along the orthogonal axis. These relationships ensure alignment parameters 130 determined in the frequency domain are accurately applicable to transform the original unaligned input image 122.

The single-ray integral module 204 receives the power spectrum 126 and performs integral calculations on this frequency domain representation for a plurality of angles. The single-ray integral module 204 implements single-ray centric integrals 128, which are a subset of a full Radon transform. For each angle of the plurality of angles, the single-ray integral module 204 computes an integral of intensity values along a central ray passing at that angle through a center point of the frequency domain representation. This approach significantly reduces computational overhead compared to conventional approaches that employ complete Radon transforms.

The single-ray integral module 204 systematically evaluates the power spectrum 126 by calculating integral values along rays at different angles, typically spanning from 0 to 180 degrees in small increments. For each angle, the single-ray integral module 204 sums intensity values of pixels along the ray passing through the center point. These calculations reveal dominant directional components in the frequency domain, corresponding to primary axes of the lattice structure in the original texture. The single-ray integral module 204 is operable to efficiently traverse pixels along each ray using interpolation methods when rays pass between pixel centers.

The single-ray integral module 204 produces the single-ray integrals 128 that quantify the strength of frequency components at different orientations, with higher integral values indicating stronger directional components in the texture pattern. These single-ray integrals 128 form the mathematical basis for identifying a rotation angle 210 and shear parameters to align the texture. This approach is particularly effective for lattice-structured textures because regular, repeating patterns create concentrated energy in the frequency domain along specific directions, which the single-ray integrals 128 efficiently detect.

The alignment parameter module 206 receives the single-ray integrals 128 and determines alignment parameters 130 for the structured texture. The alignment parameter module 206 implements a systematic approach to extract precise alignment parameters 130 from the frequency domain analysis. For each angle in the plurality of angles, the alignment parameter module 206 analyzes the corresponding integral value to identify patterns and peaks that indicate primary axes of the lattice structure.

The alignment parameter module 206 identifies, based on the integral calculations, a first angle from the plurality of angles corresponding to a first maximum integral value. This first angle is used to set a rotation angle 210 parameter, which represents the primary orientation of the lattice structure. The alignment parameter module 206 then performs additional integral calculations on the frequency domain representation for a second plurality of angles to identify a second angle corresponding to a second maximum integral value. A shear axis 212 parameter is determined based on a comparison between the rotation angle 210 parameter and the second angle. The alignment parameter module 206 then performs further integral calculations for a third plurality of angles to identify a third angle corresponding to a third maximum integral value, which is used to set a shear angle 214 parameter.

The alignment parameter module 206 leverages the properties of the power spectrum 126 to efficiently determine both rotation angle 210 and shear parameters simultaneously. This capability enables comprehensive texture alignment for complex real-world textures where both distortion types occur together. The alignment parameter module 206 implements sophisticated mathematical analysis to interpret the frequency domain patterns, distinguishing between different types of lattice structures such as quadrilateral, hexagonal, herringbone, and other patterns.

The alignment parameter module 206 decomposes the transformation into two steps: first a rotation so that one direction of the lattice is aligned with one of the two canonical axes, then a shear so that the orthogonal direction in the lattice is aligned with the second canonical axis. This decomposition ensures that the content processing system 200 is operable to realign the unaligned input image 122 up to small perspective effects. The alignment parameter module 206 employs a speedup trick that allows the alignment parameter module 206 to compute the power spectrum 126 once and estimate both basic transforms without actually performing intermediary realignments, which significantly reduces computational overhead.

The transformation module 208 generates the aligned output image 124 by modifying the unaligned input image 122 based on the alignment parameters 130. The transformation module 208 applies rotation and shear transformations to the unaligned input image 122 based on the determined rotation angle 210 parameter, shear axis 212 parameter, and shear angle 214 parameter. This sequential application of transformations ensures that the texture is properly aligned with canonical axes, making the texture suitable for seamless tiling and consistent application across digital surfaces.

The transformation module 208 implements a multi-stage transformation process that combines rotation and shear operations to align structured textures with canonical axes. This process allows for efficient and accurate alignment of textures with complex distortions that include both rotation angle 210 and shear components. The sequential application of transformations allows the transformation module 208 to perform complex alignments efficiently, such as transforming a herringbone pattern that exhibits both rotation and shear distortions into a properly aligned output image 124 with consistent orientation.

This approach enables the content processing system 200 to perform efficient and accurate alignment of structured textures across diverse scenarios, improving overall visual consistency and realism when applying textures to digital content 106. The texturing tool 116's versatility in handling various texture types and complex distortions contributes to enhanced quality and realism in digital content creation. Additionally, the content processing system 200's modular design allows for integration of new alignment techniques and texture types, facilitating adaptability to future developments in digital content creation and texture processing technologies.

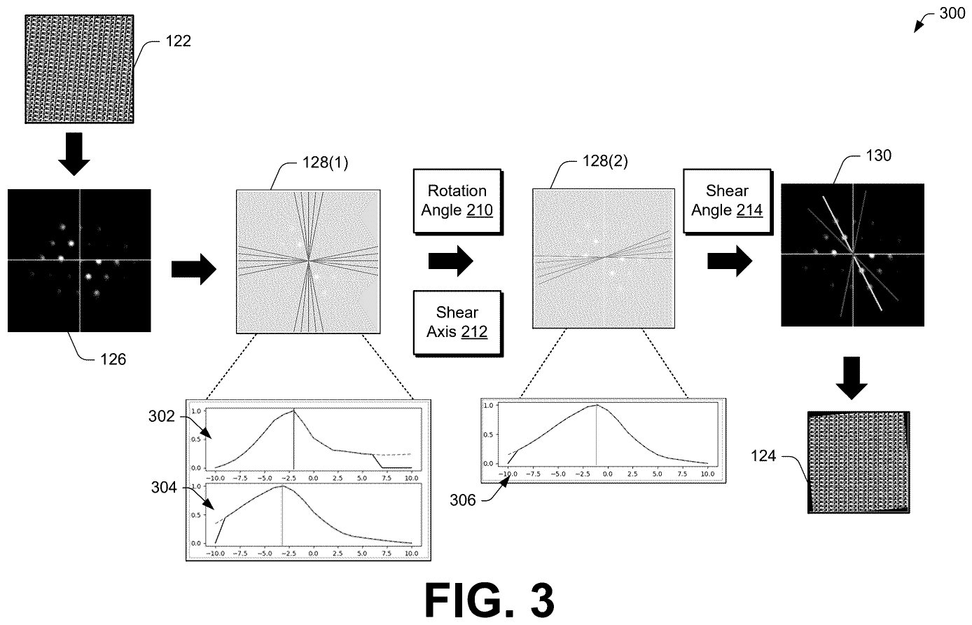

FIG. 3 illustrates a conceptual diagram of an example data flow 300 through the content processing system 200 depicted in FIG. 2 to implement alignment of structured textures. The data flow 300 demonstrates the sequential processing steps and transformations applied to the unaligned input image 122 to produce the aligned output image 124. This data flow 300, as illustrated in FIG. 3, enables the content processing system 200 to efficiently align structured textures by leveraging frequency domain analysis and targeted integral calculations.

The data flow 300 begins with the unaligned input image 122, which is provided as input to the frequency transformer module 202. The frequency transformer module 202 is operable to generate a power spectrum 126 from a crop of the unaligned input image 122. This power spectrum 126 serves as a frequency domain representation of the structured texture, revealing detailed information about the texture's repeating patterns that are not readily apparent in the spatial domain.

The power spectrum 126 is then processed by the single-ray integral module 204, which performs two stages of integral calculations. In the first stage, the single-ray integral module 204 computes a set of first single-ray integrals 128(1) on the power spectrum 126. These first single-ray integrals 128(1) are calculated for a plurality of angles, for instance, spanning from 0 to 180 degrees in small increments. The results of these calculations are plotted in a graph showing the first maximum integral value 302, which corresponds to at least one rotation angle 210 for aligning the texture. The use of single-ray integrals, as opposed to full Radon transforms, significantly reduces computational overhead while maintaining alignment accuracy.

Following the first stage, the alignment parameter module 206 analyzes the first single-ray integrals 128(1) to determine the rotation angle 210 and shear axis 212. The rotation angle 210 is identified as the angle corresponding to the first maximum integral value 302 in the plot of the first single-ray integrals 128(1). The shear axis 212 is determined based on the relationship between the identified rotation angle 210 and the overall pattern of integral values. The shear axis 212 is identified to determine at least one shear angle 214 as the second maximum integral value 304 in the plot of the first single-ray integrals 128(1). This approach is particularly effective for lattice-structured textures, where regular, repeating patterns create concentrated energy in the frequency domain along specific directions.

In the second stage, the single-ray integral module 204 computes a set of second single-ray integrals 128(2) on the power spectrum 126. These calculations are performed along the identified shear axis 212 to determine at least one shear angle 214. The results of these calculations are plotted in a graph showing the third maximum integral value 306, which corresponds to at least one shear angle 214 for aligning the texture. The data flow 300 demonstrates how the content processing system 200 is operable to simultaneously estimate rotation and shear parameters, enabling comprehensive texture alignment for complex real-world textures where both distortion types occur together.

The alignment parameter module 206 then analyzes the second single-ray integrals 128(2) to determine the shear angle 214. This shear angle 214 is identified as the angle corresponding to the third maximum integral value 306 in the plot of the second single-ray integrals 128(2). This capability provides a more complete solution than single-parameter approaches, improving the overall quality and realism of textured digital content.

The alignment parameters 130, comprising the rotation angle 210, shear axis 212, and shear angle 214, are then passed to the transformation module 208. The transformation module 208 is operable to apply these alignment parameters 130 to the unaligned input image 122, performing a sequence of geometric transformations to produce the aligned output image 124. By processing the unaligned input image 122 through this sequence of operations, the content processing system 200 is operable to produce an aligned output image 124 that is suitable for seamless tiling and consistent application across digital surfaces. The aligned output image 124 maintains the original texture's visual characteristics while eliminating misalignments that would otherwise create visual inconsistencies when applied to complex 3D geometries or tiled across large surfaces.

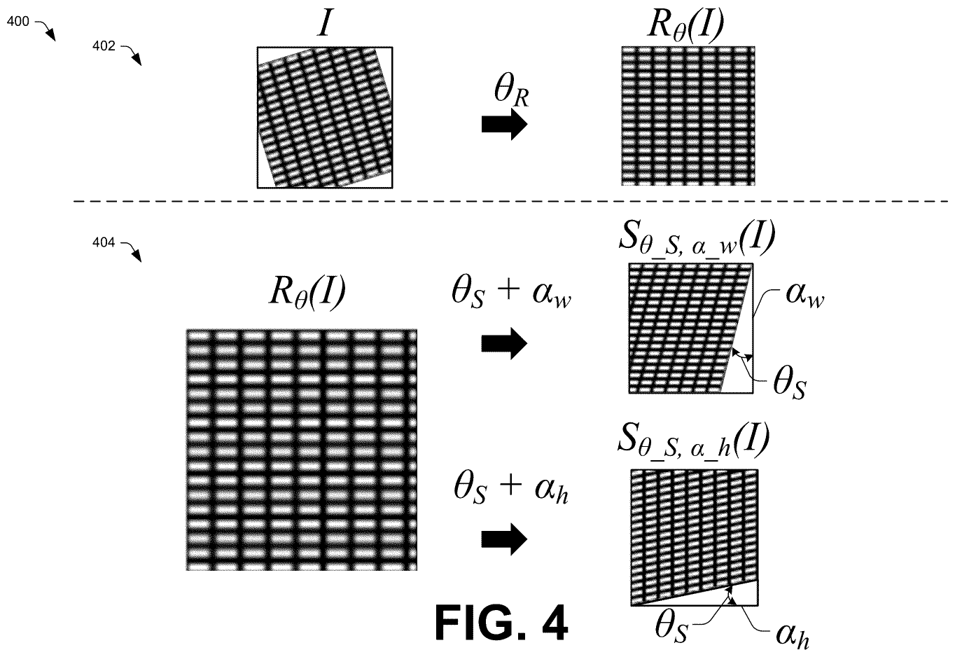

FIG. 4 illustrates a conceptual diagram of example alignment transformations 400 applied by the content processing system 200 depicted in FIG. 2 to implement alignment of structured textures. The diagram demonstrates how the unaligned input image 122, represented as I, undergoes specific geometric transformations to achieve proper alignment with canonical axes.

The alignment transformations 400 are divided into two primary examples: a rotation example 402 and a shear example 404. These examples visually represent the mathematical operations performed by the transformation module 208 based on the alignment parameters 130 determined by the alignment parameter module 206.

In the rotation example 402, the unaligned input image I is subjected to a rotation transformation R_{θ}(I), where θ represents the rotation angle 210 determined by the alignment parameter module 206. This transformation is expressed mathematically as Equation (1):

$${R}_{θ} ( I ) = I ∘ [ \begin{matrix}cos θ & - sin θ \\ sin θ & cos θ\end{matrix} ] \qquad Equation ( 1 )$$

The rotation transformation aligns one primary axis of the lattice structure with a canonical axis, as determined by the first maximum integral value 302 in the single-ray integrals 128(1).

The shear example 404 demonstrates a transformation based on shear operations. The aligned input image R_{θ}(I) is sheared by a shear angle θ_{S} relative a sheer axis α. This shear transformation is represented as S_{α,θ}(I) and is mathematically expressed as Equation (2):

$${S}_{α , θ} ( I ) = I ∘ [ \begin{matrix}1 & tan α \\ 0 & 1\end{matrix} ] ∘ [ \begin{matrix}cos θ & - sin θ \\ sin θ & cos θ\end{matrix} ] \qquad Equation ( 2 )$$

In Equation (2), θ is the shear angle 214 and α is the shear axis 212, both determined by the alignment parameter module 206 based on the single-ray integrals 128(1) and 128(2), respectively. In variations, two shear transformations occur about different shear axes α 212. For example, S_{α_w,θ}(I) is an image obtained by shearing along a vertical axis (h) and S_{α_w,e}(I) is an image obtained by shearing along a horizontal axis (w) (e.g., the horizontal axis is orthogonal or ninety degrees different than the vertical axis).

The transformation module 208 is operable to apply these transformations to derive the alignment parameters 130. This process ensures that both primary directions of the lattice structure are properly aligned with the canonical axes.

The power spectrum 126 of the unaligned input image 122 plays a role in determining these transformation parameters. The frequency transformer module 202 generates the power spectrum 126 using a Fast Fourier Transform (FFT), as shown in Equation (3):

$$P ( u , v ) = {\vert ℱ \{ I ( x , y ) \} \vert}^{2} \qquad Equation ( 3 )$$

In Equation (3), P(u,v) is the power spectrum, and F{I(x,y)} represents the Fourier transform of the input image I(x,y).

As discussed in the description of FIG. 3, the single-ray integral module 204 computes integrals along central rays in the power spectrum 126. These calculations are represented mathematically as Equation (4):

σ_{θ}(I)=Σ_{i,j∈r(θ)}I[i,j] Equation (4)

In the Equation (4), the term σ_{θ}(I) is the single-ray integral at angle θ, and r(θ) represents the set of indices that the central ray with angle θ traverses.

The alignment parameter module 206 uses these integral calculations to identify the angles corresponding to maximum integral values, which relate to one or more alignment parameters 130 for the structured texture. The rotation angle 210 is determined by finding the angle θ\_r0 that maximizes the integral value as Equation (5):

θᵣ₀=\argmax_{θ}_{ᵣ}σ_{θ}_{ᵣ}(I) Equation (5)

Similarly, the shear angle 214 is determined by finding the angle θ\_s0 that maximizes the integral value along the identified shear axis 212 as Equation (6):

θₛ₀=\argmax_{θ}_{ₛ}σ_{θ}_{ₛ}_{+θ}_{ᵣ₀}(I) Equation (6)

The transformation module 208 applies these parameters to generate the aligned output image 124, which is represented mathematically as Equation (7):

Ĩ=S_{θ}_{ₛ₀}_{,a}(R_{θ}_{ᵣ₀}(I)) Equation (7)

In Equation (7), Ĩ is the aligned output image 124, a is the shear axis 212, and R and S represent the rotation and shear transformations, respectively.

This approach enables the content processing system 200 to perform efficient and accurate alignment of structured textures across diverse scenarios. The system is operable to handle various types of lattice-structured textures, including quadrilateral, hexagonal, herringbone, checkered, polka dot, plaid, interleaved, and woven patterns. By decomposing the alignment process into distinct rotation and shear operations, the system is capable of correcting multiple types of misalignments simultaneously, improving the overall quality and realism of textured digital content 106.

The alignment transformations 400 illustrated in FIG. 4 demonstrate the system's ability to maintain the original texture's visual characteristics while eliminating distortions that would otherwise create visual inconsistencies when applied to complex digital surfaces. This capability is useful for creating tileable textures that can be seamlessly applied to 3D objects and digital surfaces of various sizes, supporting applications in architectural visualization, product design, and virtual environment creation within the digital content 106.

The content processing system 200 employs a speedup trick by computing the power spectrum 126 once for both rotation and shear estimation. This approach, combined with the use of single-ray integrals instead of full Radon transforms or Hough line detection, significantly reduces computational overhead. As a result, the method is suitable for real-time applications and can efficiently process high-resolution textures without requiring specialized hardware acceleration.

The system's robustness to variations in pattern scale and intensity is achieved through the use of the power spectrum 126, which captures the frequency information of the texture patterns regardless of their specific visual characteristics. This allows the content processing system 200 to accurately align textures captured under different conditions, such as varying distances, orientations, resolutions, or illuminances.

The relationship between transformations in image space and frequency space is leveraged to simplify the alignment process. For rotation, there is a direct correspondence between the rotation angle in both spaces, as shown in Equation (8):

P_{θ}(u,v)=P(u cos θ+v sin θ,−u sin θ+v cos θ) Equation (8)

In the Equation (8), the term P_{θ}(u,v) is the rotated power spectrum.

For shear, the power spectrum is sheared by the same angle but along the orthogonal axis compared to the image space, as represented in Equation (9):

P_{α}(u,v)=P(u+v tan α,v) Equation (9)

In the Equation (9), the term Pα(u,v) is the sheared power spectrum.

FIG. 4 illustrates these relationships, which enable efficient estimation of both rotation and shear parameters simultaneously, providing a more complete solution than conventional approaches that focus solely on rotation correction. In variations, the use of a square crop for the initial power spectrum computation simplifies these transformations and ensures accurate alignment across the texture, eliminating visual artifacts that would otherwise appear when tiling misaligned textures.

In summary, the alignment transformations 400 illustrated in FIG. 4 represent a comprehensive and efficient approach to structured texture alignment. By leveraging frequency domain analysis, optimized integral calculations, and sequential geometric transformations, the content processing system 200 is capable of handling a wide range of lattice-structured textures and correcting complex misalignments, improving the quality and realism of textured digital content.

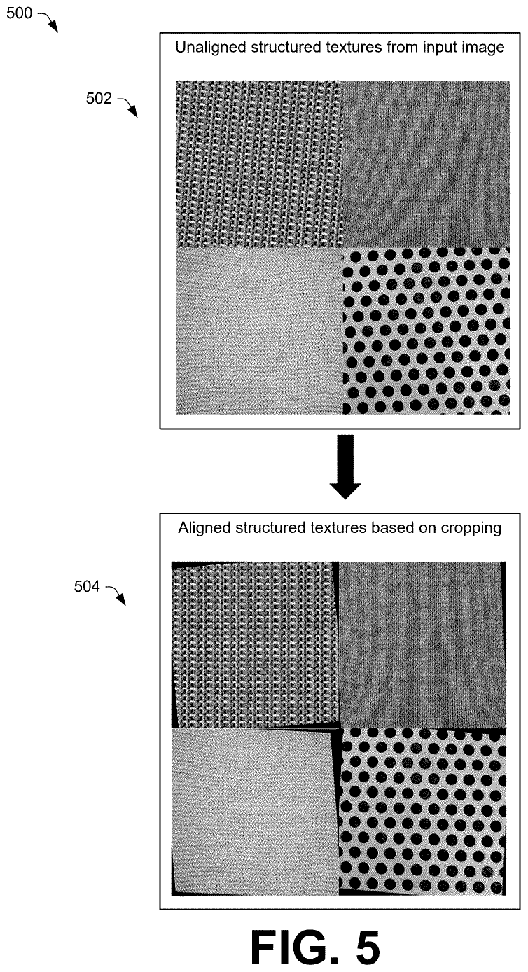

FIG. 5 is an illustration 500 of example unaligned input image crops 502 and aligned structured textures 504 generated using techniques described herein related to alignment of structured textures. FIG. 5 demonstrates the practical application and effectiveness of the texturing tool 116, and the alignment operations performed across various types of lattice-structured textures. By addressing both rotation and shear distortions simultaneously, the content processing system 200 provides a comprehensive solution for texture alignment, improving the overall quality and realism of textured digital content in various applications, from architectural visualization to game environment creation.

FIG. 5 illustrates the transformation process experienced by a user interacting with the content processing system 104 through the user interface 110. When a user provides multiple unaligned input images 122 as custom texture inputs to the user interface 110 of the texturing tool 116, the system processes 200 the unaligned input images 122 and displays both the original unaligned input image crops 502 (shown in the top section) and the resulting aligned structured textures 504 (shown in the bottom section). Each square represents a different type of lattice-structured texture that a user might upload as one of the unaligned input images 122 and the resulting aligned output images 124, including quadrilateral, hexagonal, herringbone, and other complex lattice patterns. After processing, the texturing tool 116 displays the aligned output images 124 as a selectable texture in the user interface 110, allowing the user to easily apply a selected texture for texturing digital content 106. The transformation from the slightly rotated and sheared unaligned input image crops 502 to the properly aligned structured textures 504 demonstrates how the texturing tool 116 corrects both rotation and shear distortions, producing textures suitable for seamless application to digital surfaces. The user can then select and apply these aligned textures directly from the user interface 110 displayed on the display device 112. In variations, the content processing system 104 employs efficient processing techniques that enable real-time feedback in the user interface 110, allowing users to quickly see the results of the alignment process and immediately utilize the corrected textures in their digital content projects.

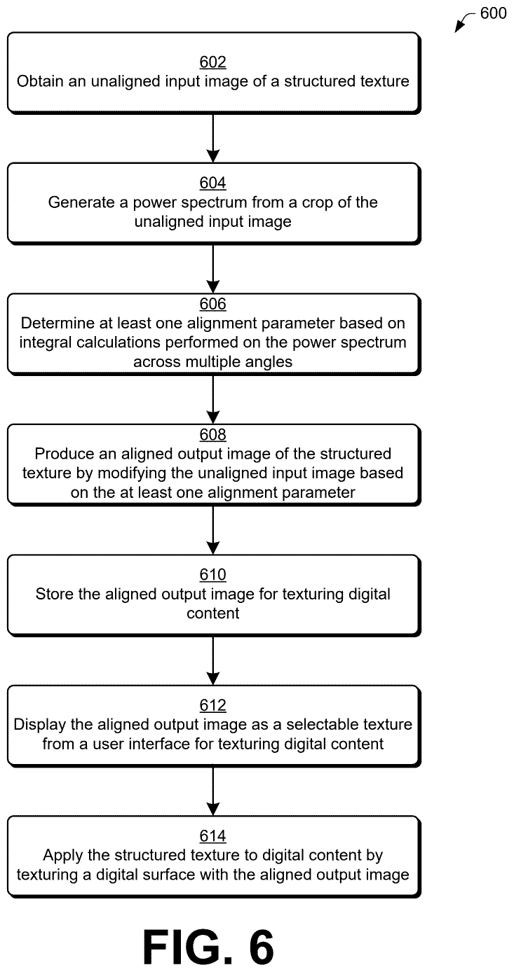

FIG. 6 is a flow diagram depicting an algorithm as a step-by-step process, which is performable by a processing device to implement techniques described herein for aligning structured textures. In various examples, the process 600 is performed by the computing device 102, the content processing system 104, the texturing tool 116, the system 200, and so forth.

The process 600 begins at block 602, where the process 600 obtains an unaligned input image of a structured texture. At least one processor of the content processing system 104 is configured, for instance, to execute the texturing tool 116 to receive the unaligned input image 122 as a custom texture input to the user interface 110 or from storage 108. The unaligned input image 122 in variations includes a lattice-structured texture with a repeating pattern that have alignment correction possibilities to be properly applied for texturing digital surfaces.

At block 604, the process generates a power spectrum from a crop of the unaligned input image. For example, the at least one processor executes the frequency transformer module 202 of the texturing tool 116 to sample a central square crop from the unaligned input image 122 and compute a power spectrum 126. This power spectrum 126 serves as a frequency domain representation that reveals detailed information about the texture's repeating patterns, enabling precise identification of structural characteristics that are difficult to detect in the spatial domain.

At block 606, the process determines at least one alignment parameter based on integral calculations performed on the power spectrum across multiple angles. The at least one processor in variations executes the single-ray integral module 204 and the alignment parameter module 206 of the texturing tool 116 to perform integral calculations on the power spectrum 126 for a plurality of angles. For each angle, the processor computes a single-ray integral 128 as an integral of intensity values along a central ray passing through the center point of the power spectrum 126. Based on these calculations, the angles corresponding to maximum integral values are identifiable by the processor, which in aspects determines alignment parameters 130 including a rotation angle 210 parameter, a shear axis 212 parameter, and a shear angle 214 parameter.

At block 608, the process produces an aligned output image of the structured texture by modifying the unaligned input image based on the at least one alignment parameter. The at least one processor, for instance, executes the transformation module 208 of the texturing tool 116 to apply rotation and shear transformations to the unaligned input image 122 based on the determined alignment parameters 130. This sequential application of transformations ensures that the texture is properly aligned with canonical axes, making it suitable for seamless tiling and consistent application across digital surfaces.

At block 610, the process stores the aligned output image for texturing digital content. The at least one processor of the content processing system 104 stores the aligned output image 124 in the digital content 106 maintained in storage 108, making the aligned output image 124 available for texturing digital content. The aligned output image 124 maintains the original texture's visual characteristics while eliminating misalignments that would otherwise create visual inconsistencies when applied to complex digital surfaces.

At block 612, the process displays the aligned output image as a selectable texture from a user interface for texturing digital content. The at least one processor of the content processing system 104 renders the aligned output image 124 in the user interface 110 displayed on the display device 112, allowing users to easily select and apply the corrected texture to digital surfaces. The user interface 110 provides options for the user to preview how the aligned texture will appear when applied to various digital surfaces.

At step 614, the process applies the structured texture to digital content by texturing a digital surface with the aligned output image. The at least one processor of the content processing system 104 applies the aligned output image 124 to digital surfaces within the digital content 106 based on user selection through the user interface 110. The properly aligned textures maintain consistent orientation across curved or complex surfaces, enhancing the realism and quality of textured digital content without the visual inconsistencies that would appear when using unaligned textures.

### Example System and Device

FIG. 7 illustrates an example system 700 including various components of an example device usable as any type of computing device as described and/or utilized with reference to FIGS. 1-6 to implement examples of the techniques described herein. FIG. 7 illustrates an example system 700 generally, which includes an example computing device 702 that is representative of one or more computing systems and/or devices that implement the various techniques described herein. This is illustrated through inclusion of the texturing tool 116. The computing device 702 is configurable, for instance, as a server of a service provider, a device associated with a client (e.g., a client device), an on-chip system, and/or any other suitable computing device or computing system.

The example computing device 702 as illustrated includes a processing system 704, one or more computer-readable media 706, and one or more I/O interface 708 that are communicatively coupled, one to another. Although not shown, the computing device 702 further includes a system bus or other data and command transfer system that couples the various components, one to another. In one or more examples, a system bus includes any one, or combination, of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 704 is representative of functionality to perform one or more operations using hardware. Accordingly, the processing system 704 is illustrated as including the hardware elements 710, which are configurable as processors, functional blocks, and so forth. This includes implementation in hardware as an application specific integrated circuit or other logic device formed using one or more semiconductors. The hardware elements 710 are not limited by the materials that form the hardware elements 710, or the processing mechanisms employed therein. For example, processors are configurable as semiconductor(s) and/or transistors, e.g., electronic integrated circuits (ICs). In such a context, processor-executable instructions are electronically executable instructions.

The computer-readable media 706 is storage media illustrated as including memory/storage 712. The memory/storage 712 represents memory/storage capacity associated with one or more computer-readable media. The memory/storage 712 is configured as a memory component, for example, which is configured to store the digital content 106. The memory/storage 712 includes volatile media (such as random access memory (RAM)) and/or nonvolatile media, such as read-only memory (ROM), Flash memory, optical disks, magnetic disks, and so forth. The memory/storage 712 includes fixed media (e.g., RAM, ROM, a fixed hard drive, and so on) as well as removable media, e.g., Flash memory, a removable hard drive, an optical disc, and so forth. The computer-readable media 706 is configurable in a variety of other ways as further described below.

Input/output interface(s) 708 are representative of functionality to allow a user to enter commands and information to computing device 702 and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., employing visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 702 is configurable in a variety of ways to support user interaction, as described herein.

Various techniques are described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques are configurable on a variety of commercial computing platforms and for a variety of processors.

An implementation of the described modules and techniques is stored on or transmitted across some form of computer-readable media. The computer-readable media includes a variety of media that is accessed by the computing device 702. By way of example, and not limitation, computer-readable media includes “computer-readable storage media” and “computer-readable signal media.”

“Computer-readable storage media” refers to media and/or devices that enable persistent and/or non-transitory storage of information in contrast to mere signal transmission, carrier waves, or signals per se. Thus, computer-readable storage media refers to non-signal bearing media. The computer-readable storage media includes hardware such as volatile and nonvolatile, removable, and non-removable media and/or storage devices implemented in a method or technology suitable for storage of information such as computer readable instructions, data structures, program modules, logic elements/circuits, or other data. Examples of computer-readable storage media include but are not limited to RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and are accessible by a computer.

“Computer-readable signal media” refers to a signal-bearing medium that is configured to transmit instructions to the hardware of the computing device 702, such as via a network. Signal media typically embodies computer readable instructions, data structures, program modules, or other data in a modulated data signal, such as carrier waves, data signals, or other transport mechanism. Signal media also include any information delivery media. The term “modulated data signal” means a signal that has one or more of signal characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 710 and computer-readable media 706 are representative of modules, programmable device logic and/or fixed device logic implemented in a hardware form that are employed in some examples to implement at least some aspects of the techniques described herein, such as to perform one or more instructions. Hardware includes components of an integrated circuit or on-chip system, an application-specific integrated circuit (ASIC), a field-programmable gate array (FPGA), a complex programmable logic device (CPLD), and other implementations in silicon or other hardware. In this context, hardware operates as a processing device that performs program tasks defined by instructions and/or logic embodied by the hardware as well as a hardware utilized to store instructions for execution, e.g., the computer-readable storage media described previously. For example, the hardware elements 710 include a processing device coupled to the memory component implemented by the memory/storage 712 to perform operations of the texturing tool 116. The operations, when executed, cause the processing device implemented by the hardware elements 710 to generate the digital content 106 stored in the memory/storage 712.

Combinations of the foregoing are also employed to implement various techniques described herein. Accordingly, software, hardware, or executable modules are implemented as one or more instructions and/or logic embodied on some form of computer-readable storage media and/or by one or more hardware elements 710. The computing device 702 is configured to implement particular instructions and/or functions corresponding to the software and/or hardware modules. Accordingly, implementation of a module that is executable by the computing device 702 as software is achieved at least partially in hardware, e.g., through use of computer-readable storage media and/or hardware elements 710 of the processing system 704. The instructions and/or functions are executable/operable by one or more articles of manufacture (e.g., at least one computing device 702 and/or processing systems 704) to implement techniques, modules, and examples described herein.

The techniques described herein are supported by various configurations of the computing device 702 and are not limited to the specific examples of the techniques described herein. This functionality is also implementable or partially implementable through use of a distributed system, such as over a “cloud” 714 via a platform 716 as described below.

The cloud 714 includes and/or is representative of a platform 716 for resources 718. The platform 716 abstracts underlying functionality of hardware (e.g., servers) and software resources of the cloud 714. The resources 718 include applications and/or data utilized while computer processing is executed on servers that are remote from the computing device 702. In at least one example, the resources 718 include services provided over the Internet and/or through a subscriber network, such as a cellular or Wi-Fi network.

The platform 716 abstracts resources and functions to connect the computing device 702 with other computing devices. The platform 716 also serves to abstract scaling of resources to provide a corresponding level of scale to encountered demand for the resources 718 that are implemented via the platform 716. Accordingly, in an interconnected device example, implementation of functionality described herein is distributable throughout the system 700. The functionality is implementable in part on the computing device 702 as well as via the platform 716 that abstracts the functionality of the cloud 714.

Although the techniques have been described in language specific to structural features and/or methodological acts, it is to be understood that the techniques defined in the appended claims are not limited to the specific features or acts described. Rather, the specific features and acts are disclosed as example forms of implementing the claims.

What is claimed is:

1. A method, the method comprising:
obtaining, by at least one processing device, an unaligned input image of a structured texture;
generating, by the at least one processing device, a power spectrum from a crop of the unaligned input image;
determining, by the at least one processing device, at least one alignment parameter based on integral calculations performed on the power spectrum across multiple angles;
producing, by the at least one processing device, an aligned output image of the structured texture by modifying the unaligned input image based on the at least one alignment parameter; and
storing, by the at least one processing device, the aligned output image for texturing digital content.

2. The method of claim 1, wherein the power spectrum includes a frequency domain representation of the crop of the unaligned input image, and the at least one alignment parameter is determined based on peaks identified from the integral calculations performed across the multiple angles at frequencies corresponding to repeating patterns in the structured texture.

3. The method of claim 1, wherein the modifying the unaligned input image includes:
applying rotation and shear transformations to the unaligned input image based on the at least one alignment parameter.

4. The method of claim 1, wherein the at least one alignment parameter includes one or more of a rotation angle parameter, a shear axis parameter, and a shear angle parameter.

5. The method of claim 1, further comprising:
receiving the unaligned input image as a custom texture input to a user interface of a digital content texturing tool; and
displaying the aligned output image as a selectable texture from the user interface for texturing the digital content.

6. A system, the system comprising:
a memory component; and
at least one processing device coupled to the memory component to perform operations, the operations including:
obtaining an unaligned input image of a structured texture;
generating a frequency domain representation of at least a portion of the unaligned input image;
performing integral calculations on the frequency domain representation for a plurality of angles;
determining, based on the integral calculations, at least one alignment parameter for the structured texture;
producing an aligned output image of the structured texture by modifying the unaligned input image based on the at least one alignment parameter; and
applying the structured texture to digital content by texturing a digital surface with the aligned output image.

7. The system of claim 6, wherein the structured texture comprises a lattice-structured texture having at least one of a quadrilateral lattice pattern, a hexagonal lattice pattern, a herringbone lattice pattern, a checkered lattice pattern, a polka dot lattice pattern, a plaid lattice pattern, an interleaved lattice pattern, or a woven lattice pattern.

8. The system of claim 6, wherein the operations that generate the frequency domain representation include:
sampling a crop of the unaligned input image; and
computing a power spectrum that exhibits peaks at frequencies corresponding to repeating patterns in the structured texture.

9. The system of claim 6, wherein the operations that perform the integral calculations include:
for each angle of the plurality of angles, computing an integral of intensity values along a central ray passing at that angle through a center point of the frequency domain representation.

10. The system of claim 6, wherein the operations that determine the at least one alignment parameter include:
identifying, based on the integral calculations, a first angle from the plurality of angles corresponding to a first maximum integral value;
setting a rotation angle parameter based on the first angle;
performing additional integral calculations on the frequency domain representation for a second plurality of angles; and
identifying a second angle from the second plurality of angles corresponding to a second maximum integral value.

11. The system of claim 6, wherein the integral calculations include a subset of a full Radon transform and are limited to central rays passing through a center point of the frequency domain representation.

12. A method, the method comprising:
obtaining, by at least one processing device, an unaligned input image of a structured texture;
generating, by the at least one processing device, a frequency domain representation of at least a portion of the unaligned input image;
performing, by the at least one processing device, integral calculations on the frequency domain representation for a plurality of angles;
determining, by the at least one processing device, at least one alignment parameter for aligning the structured texture based on the integral calculations; and
producing, by the at least one processing device, an aligned output image of the structured texture by modifying the unaligned input image based on the at least one alignment parameter.

13. The method of claim 12, wherein the structured texture comprises a lattice-structured texture having a repeating pattern of appearance across a lattice.

14. The method of claim 12, wherein the generating the frequency domain representation includes:
sampling a crop of the unaligned input image; and
computing a power spectrum of the crop that indicates peak frequencies corresponding to repeating patterns in the structured texture.

15. The method of claim 12, wherein the performing the integral calculations includes: for each angle from the plurality of angles, computing an integral of intensity values along a central ray passing at that angle through a center point of the frequency domain representation.

16. The method of claim 15, wherein the integral calculations include a subset of a full Radon transform.

17. The method of claim 12, wherein the determining the at least one alignment parameter includes:
identifying, based on the integral calculations, a first angle from the plurality of angles corresponding to a first maximum integral value; and
setting a rotation angle parameter based on the first angle.

18. The method of claim 17, further comprising:
performing additional integral calculations on the frequency domain representation for a second plurality of angles;
identifying, based on the additional integral calculations, a second angle from the second plurality of angles corresponding to a second maximum integral value; and
determining a shear axis parameter based on a comparison between the rotation angle parameter and the second angle.

19. The method of claim 18, further comprising:
performing further integral calculations on the frequency domain representation for a third plurality of angles;
identifying a third angle from the third plurality of angles corresponding to a third maximum integral value; and
setting a shear angle parameter based on the third angle.

20. The method of claim 12, wherein the modifying the unaligned input image includes:
applying a rotation transformation to the unaligned input image based on a rotation angle parameter; and
applying a shear transformation to the unaligned input image based on a shear angle parameter and a shear axis parameter.
